(19) United States
(12) Patent Application Publication
(10) Pub. No.: US 2020/0073635 A1
(43) Pub. Date: Mar. 5, 2020

(54) SYSTEMS, APPARATUSES, AND METHODS FOR VECTOR-PACKED FRACTIONAL MULTIPLICATION OF SIGNED WORDS WITH ROUNDING, SATURATION, AND HIGH-RESULT SELECTION

(71) Applicant: Intel Corporation, Santa Clara, CA (US)

(72) Inventors: Venkateswara R. MADDURI, Austin, TX (US); Elmoustapha OULD-AHMED-VALL, Chandler, AZ (US); Robert VALENTINE, Kirvat Tivon (IL); Jesus CORBAL, Barcelona (ES); Mark J. CHARNEY, Lexington, MA (US); Carl MURRAY, Dublin (IE); Milind GIRKAR, Sunnyvale, CA (US); Bret TOLL, Hillsboro, OR (US)

(21) Appl. No.: 16/613,529

(22) PCT Filed: Jun. 29, 2017
(86) PCT No.: PCT/US2017/040150

§ 371 Date: Nov. 14, 2019

(51) Int. Cl. G06F 7/499

(52) U.S. Cl. CPC G06F 7/49921; G06F 2207/3828

(57) ABSTRACT

Embodiments of systems, apparatuses, and methods for vector-packed fractional multiplication of signed words with rounding, saturation, and high-result selection in a processor are described. For example, execution circuitry executes a decoded instruction to perform a fractional multiplication operation for each of a plurality of pairs of packed data elements to yield a plurality of output values, round each of the plurality of output values, detect whether any of the plurality of output values reflect an overflow or underflow, for any of the plurality of output values that reflect an overflow or underflow, saturate the output value, and store the plurality of output values into a corresponding plurality of positions of the packed data destination operand.

### TECHNICAL FIELD

The field relates generally to computer processor architecture, and, more specifically, to instructions which when executed cause a particular result.

### BACKGROUND

Significant developments in modern computing have arisen due to efforts to impart human abilities to computers. Many of these efforts have harnessed and extended relatively nascent techniques from the fields of machine learning, computer vision, speech recognition, and digital signal processing. However, these techniques are often extremely computationally expensive and require significant computing resources and time to implement them.

### BRIEF DESCRIPTION OF THE DRAWINGS

Embodiments are illustrated by way of example and not limitation in the figures of the accompanying drawings, in which like references indicate similar elements and in which:

FIG. 1 illustrates an exemplary execution of a vector-packed fractional multiplication of signed words with rounding, saturation, and high-result selection instruction according to some embodiments.

FIG. 2 illustrates an exemplary execution of a vector-packed fractional multiplication of signed words with rounding, saturation, and high-result selection instruction according to some embodiments.

FIG. 3 illustrates hardware of an embodiment to process an instruction such as a vector-packed fractional multiplication of signed words with rounding, saturation, and high-result selection instruction according to some embodiments.

FIG. 4 illustrates an embodiment of a method performed by a processor to process a vector-packed fractional multiplication of signed words with rounding, saturation, and high-result selection instruction according to some embodiments.

FIG. 5A illustrates an exemplary Advanced Vector Extensions (AVX) instruction format.

FIG. 5B illustrates which fields from FIG. 5A make up a full opcode field and a base operation field.

FIG. 5C illustrates which fields from FIG. 5A make up a register index field.

FIG. 6 is a block diagram of a register architecture according to some embodiments.

FIG. 7A is a block diagram illustrating both an exemplary in-order pipeline and an exemplary register renaming, out-of-order issue/execution pipeline according to embodiments.

FIG. 7B is a block diagram illustrating both an exemplary embodiment of an in-order architecture core and an exemplary register renaming, out-of-order issue/execution architecture core to be included in a processor according to some embodiments.

FIGS. 8A-8B illustrate a block diagram of a more specific exemplary in-order core architecture, which core would be one of several logic blocks (including other cores of the same type and/or different types) in a chip according to some embodiments.

FIG. 9 is a block diagram of a processor that may have more than one core, may have an integrated memory controller, and may have integrated graphics according to some embodiments.

FIG. 10 is a block diagram of a system in accordance with some embodiments.

FIG. 11 is a block diagram of a first more specific exemplary system in accordance with some embodiments.

FIG. 12 is a block diagram of a second more specific exemplary system in accordance with some embodiments.

FIG. 13 is a block diagram of a SoC in accordance with some embodiments.

FIG. 14 is a block diagram contrasting the use of a software instruction converter to convert binary instructions in a source instruction set to binary instructions in a target instruction set according to some embodiments.

### DETAILED DESCRIPTION

In the following description, numerous specific details are set forth. However, it is understood that embodiments may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### VPMULWFRS Instruction

### Exemplary Execution

Detailed herein are embodiments of a VPMULWFRS instruction to improve a computer itself. In particular, the execution of the VPMULWFRS instruction causes the fractional multiplication (e.g., Q15 multiplication) of signed words from two vector-packed sources indicated by the instruction. The output of each multiplication is rounded and saturated (if needed), and the high result (e.g., 16-bits) from the result (e.g., 32-bit) is stored into a destination indicated by the instruction. In some embodiments, a value (e.g., one or more bits of a register, such as a control/status register like the MXCSR register) can be used to determine what type of rounding is to be performed, and another value (e.g., one or more bits of a same register or another register) can be set to indicate whether saturation resulted from the operations.

In some embodiments, the execution of a VPMULWFRS instruction causes an execution circuit (or execution unit) to perform operations for vector-packed fractional multiplication of signed words with rounding, saturation, and high-result selection. In some embodiments, the execution of a VPMULWFRS instruction does not generate any faults or exceptions.

In some embodiments, the operations include performing a fractional multiplication operation for each of a plurality of pairs of packed data elements to yield a plurality of output values, where each pair of the plurality of pairs includes a first packed data element of a first packed data source operand and a second packed data element at a corresponding position in a second packed data source operand, where each data element is 16 bits and stores a signed value, and where each of the plurality of output values is 32 bits; rounding each of the plurality of output values; detecting whether any of the plurality of output values reflect an overflow or underflow; for any of the plurality of output values that reflect an overflow or underflow, saturating the output value; and storing the plurality of output values into a corresponding plurality of positions of the packed data destination operand.

To perform these operations using existing conventional techniques, a large number of separate, correctly-ordered instructions would be required to perform each multiplication with the packed data elements of the packed data sources, perform shifting, perform rounding, check for saturation, and saturate the result. Embodiments disclosed herein utilizing the VPMULWFRS instruction can perform all of these operations, consistently in the correct order, using just one instruction. In some embodiments, a processor supporting the VPMULWFRS instruction can thus perform these operations significantly faster (and typically, with less power) than conventional processors due in part to the reduction in required instructions, reduce the complexity of application and/or compiler logic needed to generate instructions to perform these tasks, etc.

The VPMULWFRS instruction can be used for a wide variety of purposes, and can be particularly useful for a number of algorithms that include performing fractional vector multiplication, rounding, and saturation. Moreover, by performing these operations for multiple elements at a time (e.g., in some embodiments 8 pairs of values packed into two sources can be operated upon with one instruction), the VPMULWFRS instruction can be particularly applicable for a wide range of complicated algorithms based on matrix operations.

For example, the VPMULWFRS instruction can be beneficially used for a wide range of speech recognition/audio processing algorithms, such as those performing feature extraction (e.g., Mel Frequency Cepstral Coefficient, or “MFCC”), correlation-based spectral subtraction (to remove periodic background noise, such as fan noise, from speech), linear predictive coding for speech, etc. As another example, the VPMULWFRS instruction can be beneficially used for implementing computer vision/motion sensing applications, such as those performing feature extraction (e.g., edge detection), motion or gesture detection based on the Sum of Absolute Difference (SAD) measure, feature tracking (e.g., tracking the feature of an object in motion using the Kanade—Lucas—Tomasi (KLT) feature tracker algorithm), discrete cosine transform (DCT) calculations, etc. As another example, the VPMULWFRS instruction can be beneficially used for implementing data fusion/motion tracking applications, including implementing a Kalman filter for motion tracking, etc. As another example, the VPMULWFRS instruction can be beneficially used for implementing deep learning applications (e.g., multi-layered perceptron-based neural networks).

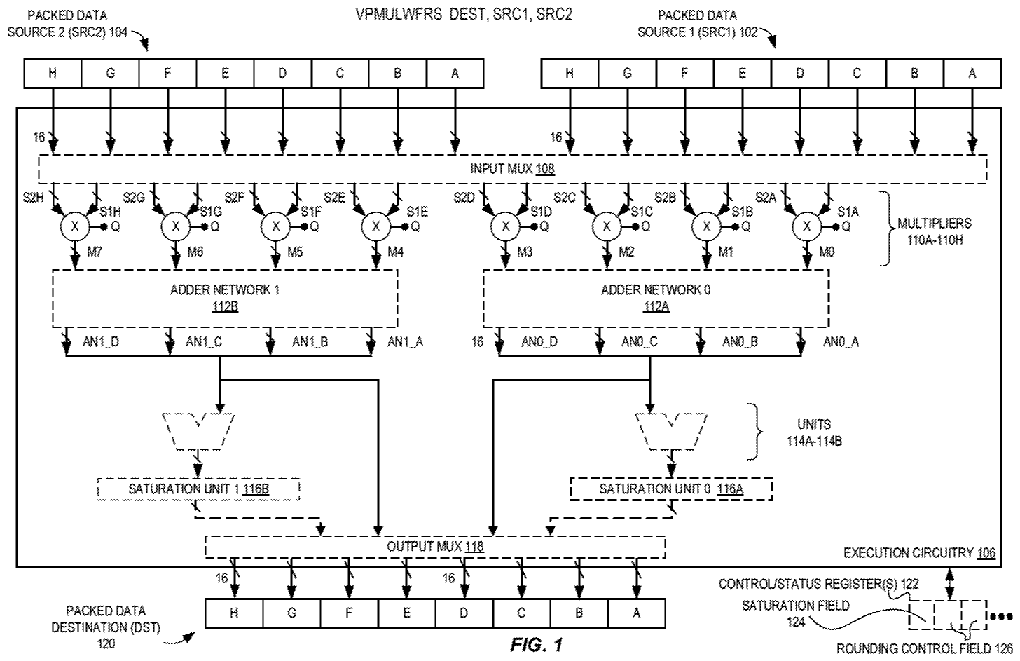

FIG. 1 illustrates an exemplary execution of a VPMULWFRS instruction. The VPMULWFRS instruction format includes fields for a destination (packed data destination (DST) 120) and two sources (packed data source 1 (SRC1) 102 and packed data source 2 (SRC2) 104). The destination and/or sources, in various embodiments, can be registers (e.g., an XMM, YMM, ZMM, vector, SIMD, D, S, etc. register) or memory locations. For example, in some embodiments, the VPMULWFRS instruction utilizes a register as the destination, a register as the first source, and either a register or a memory location for the second source. One example instruction of this configuration could be represented as “VPMULWFRS xmm1, xmm2, xmm3/m128”.

Packed data source 1 102 includes eight packed data elements (shown as locations A-H), though in other embodiments the packed data source 1 102 could include more or fewer data elements. For example, packed data source 1 102 can be 128 bits in size and pack data elements having a size of 8-bits, 16-bits, 32-bits, etc. In some embodiments, packed data source 1 102 is a packed data register, though in other embodiments packed data source 1 102 can be a memory location.

Similarly, packed data source 2 104 also includes eight packed data elements (shown as locations A-H), though in other embodiments the packed data source 2 104 could include more or fewer data elements. In some embodiments, packed data source 2 104 is a packed data register, though in other embodiments packed data source 2 104 can be a memory location.

In some embodiments, the packed data elements from packed data source 1 102 and packed data source 2 104 comprise a set of bit values representing a signed number. For example, in some embodiments each of the packed data elements is a 16-bit value representing a signed Q15 number, which includes one bit value to indicate the sign of the number (e.g., as in two's complement formats), and 15 bit values to represent the fractional aspect of the number. As is known to those of skill in the art, “Q” numbers are values represented in a fixed-point number format where the number of fractional bits (and optionally, the number of integer bits) is specified. For example, a “Q15” number has 15 fractional bits, whereas a “Q1.14” number has 1 integer bit and 14 fractional bits.

In some embodiments, values stored in one or more control/status register(s) 122 may be used to control the operation of the execution circuitry 106 when performing operations for the VPMULWFRS instruction and/or used by the execution circuitry 106 to report back information regarding the execution of these operations. For example, in some embodiments the control/status register(s) 122 include one or more “rounding control” bit value locations (a rounding control field 126) that can be set to indicate the type of rounding that is to be performed responsive to the VPMULWFRS instruction. In some embodiments, the control/status register(s) 122 can include one or more “saturation” bit value locations (a saturation field 124) that can be set by the execution circuitry 106 to indicate whether saturation occurred. The control/status register(s) 122 can be, for example, a MXCSR register, and the rounding control field 126 (also referred to as an “IRM” field) may comprise two bit locations, and/or the saturation field 124 (also referred to as a “Sat” bit) may comprise a single bit location.

The two packed data sources 102, 104 are fed into execution circuitry 106 to be operated on. In particular, execution circuitry 106 performs vector-packed fractional multiply of signed words with rounding, saturation, and high-result selection. As used herein, a “word” generally is used to refer to 16 bits of data, although in different implementations a word can refer to more or fewer bits of data, such as 8 bits, 32 bits, 64 bits, etc.

In this example, execution circuitry 106 includes an input multiplexer (mux) 108, a plurality of multipliers 110A-110H, a plurality of adder networks 112A-112B (or “accumulators”), a plurality of arithmetic logic units (ALUs) 114A-114B, a plurality of saturation units 116A-116B, and an output mux 118. However, other configurations with more, fewer, and/or different types of circuitry can be utilized to achieve the same result.

The data elements from the two packed data sources 102, 104 are fed into execution circuitry 106 and may be provided to input mux 108, which causes each pair of corresponding data elements from the two packed data sources 102, 104 to be provided to ones of the multipliers 110A-110H. For example, the “H” data element from the two packed data sources 102, 104 can be provided to a first multiplier 110A, shown as “S2H” and “S1H.” The multipliers 110A-110H can perform fractional multiplication operations with these 16-bit Q15 data elements to output a set of 32-bit multiplicative results, labeled here as M0-M7, which may be provided to adder networks 112A-112B.

In some embodiments, each pair of corresponding data elements from the two packed data sources 102, 104 may be analyzed to determine whether both data elements of each pair of data elements is a “−1” value. Because the result of such a multiplication (−1*−1=+1) cannot be represented with a 16-bit signed Q15 value (which can represent values from −1 to 0.999969482421875), this case can be detected and the result can be saturated to the maximum positive number (also referred to herein as “SAT_POS”). This analysis can occur in parallel to the multiplications, though in some embodiments it may occur before or after one or more (or all) of the multiplications.

Next, the partial products (generated by the multipliers 110A-110H) and accumulator may go through the carry-save adder compression and muxing (e.g., at output mux 118) to generate the result.

In some embodiments, rounding may be performed by the saturation units 116A-116B. As indicated here, a Control and Status Register 122 (“MXCSR”) may store 2-bits (e.g., MXCSR [23:22]) that provide the Integer Rounding Mode Control (IRM) in a rounding control field 126. For example, the following bit values may represent the following different rounding types.

Thus, the saturation units 116A-116B may use the values of the rounding control field 126 of the control/status register 122 to determine a “round bit” based on the lower 16-bits of the multiplication result. For example, if the rounding type is “Truncate,” the round bit may be 1′b0; if the rounding type is “round up,” the round bit may be the value of the 15^{th} bit of the multiplication result (or SRC[14], where SRC is an array of bit values); if the rounding type is convergent (or “even rounding”), the round bit may be the 16^{th} bit of the multiplication result when the first 15 bits are equal to 0x4000, and may be the 15^{th} bit of the multiplication when the first 15 bits are not equal to 0x4000. In some embodiments, this determined round bit can be added to the sign-extended multiplier output bits [30:15] (i.e., the “high” result).

As indicated above, values from the control/status register(s) 122 can be used to control the rounding operations and/or report whether saturation has occurred. For example, in some embodiments a value can be set in a rounding control field 126 of the control/status register(s) 122—and then read by (or otherwise provided to) execution circuitry 106. The rounding value can be, for example, a two-bit value, which can allow for up to four different rounding types to be selected between.

For example, in some embodiments, a bit value of two zeros (‘00’) may indicate that “even rounding” (or “convergent” rounding) is to be performed, which indicates that the value is to be rounded to the nearest even value. Similarly, a bit value of a one followed by a zero (‘10’) may indicate that “rounding up” is to be performed, which could be performed (as for 2's complement values) by adding ½ of the least significant bit to the result and then truncating that resultant value. Additionally, a bit value of two ones (‘11’) may indicate that the rounding is to be a truncation (an eliminating or “dropping”) of extra bits.

Additionally, in some embodiments the saturation units 116A-116B can determine whether saturation is to be performed based upon detecting overflow or underflow. For example, based on the 16^{th} and 17^{th} bits of the temporary result (e.g., TEMP[16:15]), the 16-bit result can be saturated to a most positive (0x7FFF) or most negative (0x8000) value. Otherwise, the result can be determined from the lower 16-bits of the temporary result value—e.g., TEMP[15:0].

When a saturation occurs—here, in the saturation units 116A-116B based upon detected underflow/overflow, or as described above when the special case of “−1”*“−1” is detected, a saturation field 124 of the control/status register(s) 122 can be set to indicate that the saturation occurred. For example, the MXCSR.SAT bit (e.g, MXCSR[20]) can be set to indicate that the saturation has occurred. Thus, in some embodiments, a value in a saturation field 124 of the control/status register(s) 122 can be updated when the execution circuity 106 detects that saturation has occurred responsive to the fractional multiplication. For example, in some embodiments the saturation field 124 can be a single bit location that can ordinarily be a zero but set to a value of one when saturation is detected.

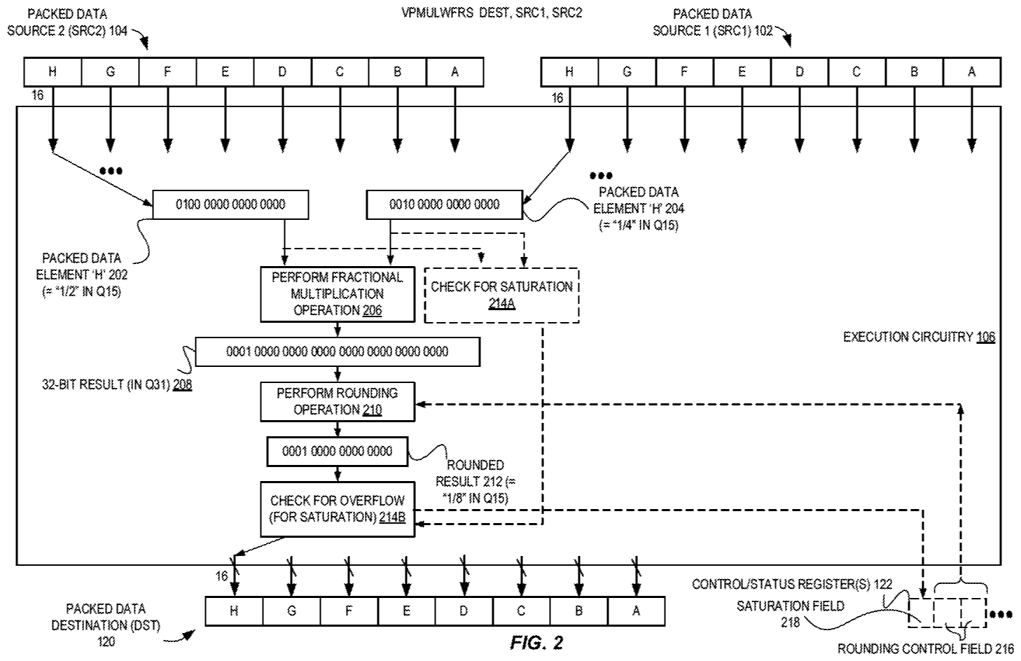

For ease of understanding, FIG. 2 illustrates another exemplary execution of a VPMULWFRS instruction by execution circuitry with a focus upon the operations for one pair of packed data elements from the packed data sources 102, 104. In FIG. 2, exemplary operations are shown with regard to each packed data element ‘H’ and the other operations for the other pairs are not shown for the sake of clarity. Thus, it is to be understood that similar operations would also be performed for each of the other pairs responsive to a single VPMULWFRS instruction. Additionally, the operations shown in this figure are represented without certain details to avoid confusion; for example, certain operations may utilize sign-extended versions of the data (e.g., 17-bit signed extended versions of the 16-bit packed data elements), though this is not shown here.

In FIG. 2, we assume that the first packed data element “H” 202 from the packed data source 2 104 is a signed word representation of one-eighth (“⅛” or 0.125) in Q15 form (i.e., 0x4000 or “0100 0000 0000 0000”), and we assume that the second packed data element “H” 204 from the packed data source 1 102 is a signed word representation of one-fourth (“¼” or 0.25) in Q15 form (i.e., 0x2000 or “0010 0000 0000 0000”).

The first packed data element “H” 202 and the second packed data element “H” 204 are fractionally multiplied at block 206 to produce a 32-bit result 208, which is encoded in Q30 as 0x08000000. In some embodiments, the execution circuitry 106 may also perform a check for saturation at block 214A (e.g., checking whether both packed data elements represent a −1 value) and may perform a saturation if this condition is met (or allow it to occur later in the process, such as at block 214B). This check for saturation at block 214A may occur in parallel with the fractional multiplication operations block 206. The execution circuitry 106 performs rounding operations at block 210 using a rounding type indicator (e.g., from rounding control field 126) to determine how to round this result 208 to cause the 32-bit result 208 (in Q30) to be changed into a 16-bit rounded result 212 (in Q15), shown as 0x1000 (or “0001 0000 0000 0000”). At block 214, the execution circuitry 106 checks for underflow and/or overflow. In this simple example, no underflow or overflow exists, and thus the rounded result 212 is stored in the corresponding packed data element location “H” of the packed data destination 120. However, when underflow or overflow is detected at block 214B (either due to the multiplication and/or a special case detected at block 214A), the execution circuitry 106 may update the saturation field 124 to indicate that the underflow/overflow occurred, and may—instead of storing the rounded result 212 in the packed data destination 120—store a saturated value (i.e., maximum or minimum value) in the packed data destination 120 instead.

### Exemplary Pseudocode Corresponding to the VPMULWFRS Instruction

The following pseudocode illustrates the conceptual set of operations performed resultant to the VPMULWFRS instruction and is provided for the sake of understanding. Thus, it is to be understood that these particular operations do not necessarily need to be implemented as other techniques exist that are known or derivable by those of skill in the art, and that these operations need not be implemented in this particular order, and so on.

In Table 1, the operations include performing a straightforward set of fractional multiplications for each pair of corresponding data elements from each of the sources. For example, in the first line, the first word of the first source (SRC1) indicated by the instruction is fractionally multiplied with the corresponding first word of the second source (SRC2) indicated by the instruction. The thirty-two (32) bit value resulting from each multiplication is referred to as an intermediate/temporary value “TEMP0.” This same fractional multiplication occurs for each other pair of the packed data elements from the two sources, thus generating TEMP0-TEMP7.

The generated temporary values TEMP0-TEMP7 can be used to generate a corresponding ultimate result, which is reflected as a word (e.g., 16 bits) of the destination (DEST) indicated by the instruction. For example, a routine called “Q15FractionalRoundSaturateToSignedWord” can be begun for each temporary value, which uses as input values the temporary value, two bits of a rounding value (from the control/status register(s) 122, here referred to as MXCSR.IRM[1:0]) to control the rounding, and the destination where the ultimate result is to be stored.

TABLE 1
TEMP0[31:0] ← (SRC1[15:0] * SRC2[15:0]);
TEMP1[31:0] ← (SRC1[31:16] * SRC2[31:16]);
TEMP2[31:0] ← (SRC1[47:32] * SRC2[47:32]);
TEMP3[31:0] ← (SRC1[63:48] * SRC2[63:48]);
TEMP4[31:0] ← (SRC1[79:64] * SRC2[79:64]);
TEMP5[31:0] ← (SRC1[95:80] * SRC2[95:80]);
TEMP6[31:0] ← (SRC1[111:96] * SRC2[111:96]);
TEMP7[31:0] ← (SRC1[127:112] * SRC2[127:112]);
DEST[15:0] ← Q15FractionalRoundSaturateToSignedWord(TEMP0[31:0],
MXCSR.IRM[1:0], DEST[15:0]);
DEST[31:16] ← Q15FractionalRoundSaturateToSignedWord (TEMP1[31:0],
MXCSR.IRM[1:0], DEST[31:16]);
DEST[47:32] ← Q15FractionalRoundSaturateToSignedWord (TEMP2[31:0],
MXCSR.IRM[1:0], DEST[47:32]);
DEST[63:48] ← Q15FractionalRoundSaturateToSignedWord (TEMP3[31:0],
MXCSR.IRM[1:0], DEST[63:48]);
DEST[79:64] ← Q15FractionalRoundSaturateToSignedWord (TEMP4[31:0],
MXCSR.IRM[1:0], DEST[79:64]);
DEST[95:80] ← Q15FractionalRoundSaturateToSignedWord (TEMP5[31:0],
MXCSR.IRM[1:0], DEST[95:80]);
DEST[111:96] ← Q15FractionalRoundSaturateToSignedWord (TEMP6[31:0],
MXCSR.IRM[1:0], DEST[111:96]);
DEST[127:112] ← Q15FractionalRoundSaturateToSignedWord (TEMP7[31:0],
MXCSR.IRM[1:0], DEST[127:112]);

An exemplary “Q15FractionalRoundSaturateToSignedWord” routine is shown in Table 2. A first pseudocode block—including an IF, ELSE IF, and ELSE—shows one exemplary procedure for setting a “Round Bit” value that can be used to implement the particular rounding type (e.g., as indicated by the rounding control field 126 value). A second pseudocode block—including an IF and an ELSE—shows one exemplary procedure for detecting one particular positive saturation that may have occurred and setting a SAT_POS flag when it is detected. Thereafter, as shown by the last line of the routine, an “AddBitSaturateToSignedWord” routine can be called with the “high” result of the fractional multiplication (e.g., the high 16-bits), the round bit value (TEMP_RoundBit), the value of the SAT_POS flag, a 0-bit (effectively, to negate a “negative saturation” flag that could be utilized), and the ultimate destination location.

TABLE 2
Q15FractionalRoundSaturateToSignedWord(SRC[31:0],
MXCSR.IRM[1:0],
DEST[15:0]):
IF (MXCSR.IRM[1:0] == 2’b11) THEN (* Truncate *)

TEMP_RoundBit ← 1’b0;

ELSE IF (MXCSR.IRM[1:0] == 2’b10) THEN (* Round Up *)

TEMP_RoundBit ← SRC[14];

ELSE (* Convergent Rounding *)

TEMP_RoundBit ← (SRC[14:0] == 0x4000) ? SRC[15] : SRC[14];

IF (SRC[31:0] == 0x4000_0000) (* A ==0x8000; B = 0x8000;
(−1*−1 = 1) *)

SAT_POS = 1;

ELSE

SAT_POS = 0;

DEST[15:0] ← AddBitSaturateToSignedWord(SRC[30:15] ,
TEMP_RoundBit, SAT_POS,
1’b0, DEST[15:0]);

An exemplary “AddBitSaturateToSignedWord” routine is shown in Table 3. A first pseudocode line provides for rounding of the result value by generating a temporary word “TEMP” via adding a first value (16 zeros and a concatenated RoundBit, generated as shown above in Table 2) with a second value (the value of bit location 15 of the source, together with bits 15-0 of the source). Based upon the RoundBit generated above in Table 2, this line will implement the desired type of rounding as specified by the value of the rounding control field 126 (MXCSR:IRM[1:0]).

Next, in an IF-ELSE IF-ELSE block, saturation can be detected in the “IF” and “ELSE IF” portions. The “IF” block seeks to detect one type of “positive” overflow (e.g., when −1 is multiplied by −1 as shown above in Table 2, or when rounding lead to overflow), and thus the ultimate output (DEST) can be set to the most-positive number able to be represented, and the saturation value (of the control/status register(s) 122) can be set (e.g., MXCSR.Sat can be set to ‘1’) to report the saturation. The “ELSE IF” block similarly checks for underflow, and when it is found, the ultimate output (DEST) can be set to the most-negative number able to be represented, and the saturation value (of the control/status register(s) 122) can be set (e.g., MXCSR.Sat can be set to ‘1’) to report the saturation.

If neither type of saturation is detected, the routine continues to the ELSE block and sets the ultimate destination value to be that of the temporary word (TEMP). Accordingly, Table 2 and Table 3 can be performed for each pair of packed data elements (signed words) from the two packed data sources 102, 104 to round the result of the fractional multiplication of the signed words, detect (and report, when found) saturation, and store the “high” result (e.g., the most-significant half of the result of the multiplication).

TABLE 3
AddBitSaturateToSignedWord(SRC[15:0], RoundBit, SAT_POS,
SAT_NEG,
DEST[15:0]):
TEMP[16:0] ← ({16’b0, RoundBit} + {SRC[15], SRC[15:0]});
IF (((TEMP[16] == 1’b0) AND (TEMP[15] == 1’b1)) OR SAT_POS)

DEST[15:0] ← 0x7FFF; (* Most Positive Number *)
MXCSR.Sat ← 1;

ELSE IF (((TEMP[16] == 1’b1) AND (TEMP[15] == 1’b0)) OR
SAT_NEG)

DEST[15:0] ← 0x8000; (* Most Negative Number *)
MXCSR.Sat ← 1;

ELSE

DEST[15:0] ← TEMP[15:0];

### Exemplary Hardware to Execute the VPMULWFRS Instruction

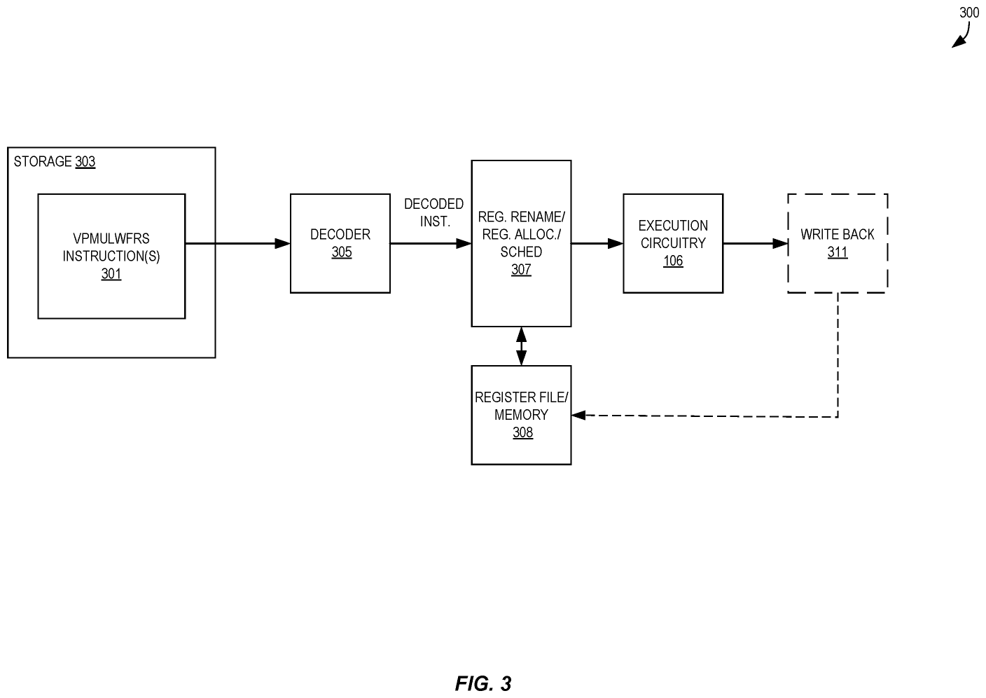

FIG. 3 illustrates an embodiment of hardware to process an instruction such as a Vector Packed Fractional Multiply of Signed Words, with Round, Saturate and Store High Result instruction. As illustrated, storage 303 stores a VPMULWFRS instruction 301 to be executed.

The instruction is received by decode circuitry 305. For example, the decode circuitry 305 receives this instruction from fetch logic/circuitry. The instruction 301 includes fields for an opcode, first and second sources, and a destination. In some embodiments, the sources and destination are registers, and in other embodiments one or more are memory locations. More detailed embodiments of at least one instruction format will be detailed later. The decode circuitry 305 decodes the instruction into one or more operations. In some embodiments, this decoding includes generating a plurality of micro-operations to be performed by execution circuitry (such as execution circuitry). The decode circuitry 305 also decodes instruction prefixes (if used).

In some embodiments, register renaming, register allocation, and/or scheduling circuitry 307 provides functionality for one or more of: 1) renaming logical operand values to physical operand values (e.g., a register alias table in some embodiments), 2) allocating status bits and flags to the decoded instruction, and 3) scheduling the decoded instruction for execution on execution circuitry out of an instruction pool (e.g., using a reservation station in some embodiments).

Registers (register file) and/or memory 308 store data as operands of the instruction to be operated on by execution circuitry. Exemplary register types include packed data registers, general purpose registers, and floating-point registers.

Execution circuitry executes 106 the decoded VPMULWFRS instruction. Exemplary detailed execution circuitry was shown in FIG. 1. The execution of the decoded VPMULWFRS instruction causes the execution circuitry to perform operations for vector-packed fractional multiplication of signed words with rounding, saturation, and high-result selection as described herein.

Write back (retirement) circuitry 311 commits the result of the execution of the decoded VPMULWFRS instruction. In some embodiments, retirement/write back circuitry architecturally commits the destination register into the registers or memory and retires the instruction.

### Exemplary Formats of the VPMULWFRS Instruction

An embodiment of a format for a VPMULWFRS instruction is VPMULWFRS DSTREG, SRC1, SRC2. In some embodiments, VPMULWFRS is the opcode mnemonic of the instruction. In some embodiments, DSTREG is a field for the packed data destination register operand, and SRC1 and SRC2 are fields for the sources such as packed data registers and/or memory. For example, in some embodiments, the DSTREG is an xmm register, the SRC1 is an xmm register, and the SRC2 is either an xmm register or a memory location. In some embodiments, SRC1 may be a “vvvv” value (such as 520), and in some embodiments, SRC2 may be a R/M value (such as 546).

In embodiments, encodings of the instruction include a scale-index-base (SIB) type memory addressing operand that indirectly identifies multiple indexed destination locations in memory. In one embodiment, an SIB type memory operand may include an encoding identifying a base address register. The contents of the base address register may represent a base address in memory from which the addresses of the particular destination locations in memory are calculated. For example, the base address may be the address of the first location in a block of potential destination locations for an extended vector instruction. In one embodiment, an SIB type memory operand may include an encoding identifying an index register. Each element of the index register may specify an index or offset value usable to compute, from the base address, an address of a respective destination location within a block of potential destination locations. In one embodiment, an SIB type memory operand may include an encoding specifying a scaling factor to be applied to each index value when computing a respective destination address. For example, if a scaling factor value of four is encoded in the SIB type memory operand, each index value obtained from an element of the index register may be multiplied by four and then added to the base address to compute a destination address.

In one embodiment, an SIB type memory operand of the form vm32{x,y,z} may identify a vector array of memory operands specified using SIB type memory addressing. In this example, the array of memory addresses is specified using a common base register, a constant scaling factor, and a vector index register containing individual elements, each of which is a 32-bit index value. The vector index register may be a 128-bit register (e.g., XMM) register (vm32x), a 256-bit (e.g., YMM) register (vm32y), or a 512-bit (e.g., ZMM) register (vm32z). In another embodiment, an SIB type memory operand of the form vm64{x,y,z} may identify a vector array of memory operands specified using SIB type memory addressing. In this example, the array of memory addresses is specified using a common base register, a constant scaling factor, and a vector index register containing individual elements, each of which is a 64-bit index value. The vector index register may be a 128-bit register (e.g., XMM) register (vm64x), a 256-bit (e.g., YMM) register (vm64y) or a 512-bit (e.g., ZMM) register (vm64z).

### Exemplary Method of Execution of the VPMULWFRS Instruction

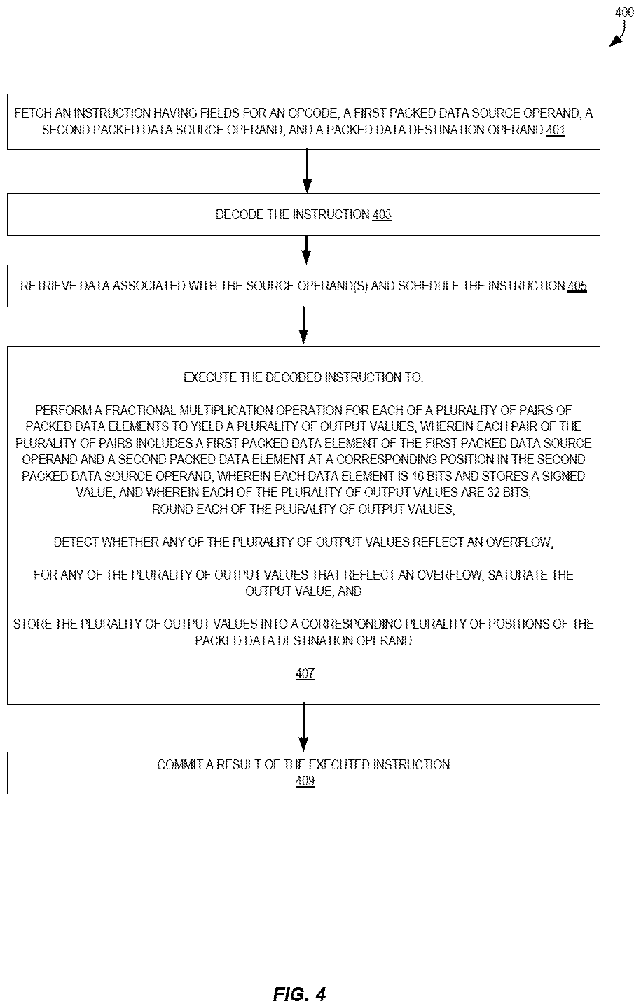

FIG. 4 illustrates an embodiment of method performed by a processor to process a VPMULWFRS instruction. For example, the processor components of FIG. 3, a pipeline as detailed below, etc., performs this method.

At 401, an instruction is fetched. For example, a VPMULWFRS instruction is fetched. The VPMULWFRS instruction includes fields for an opcode, a first and a second source operand, and a destination operand. In some embodiments, the instruction is fetched from an instruction cache. The source and destination operands are packed data.

The fetched instruction is decoded at 403. For example, the fetched VPMULWFRS instruction is decoded by decode circuitry such as that detailed herein.

Data values associated with the source operands of the decoded instruction are retrieved at 405 and the decoded instruction is scheduled (as needed). For example, when one or more of the source operands are memory operands, the data from the indicated memory location is retrieved.

At 407, the decoded instruction is executed by execution circuitry (hardware) such as that detailed herein. For the VPMULWFRS instruction, the execution will cause execution circuitry to perform operations for vector-packed fractional multiplication of signed words with rounding, saturation, and high-result selection. In some embodiments, execution will cause execution circuitry to perform a fractional multiplication operation for each of a plurality of pairs of packed data elements to yield a plurality of output values, where each pair of the plurality of pairs includes a first packed data element of the first packed data source operand and a second packed data element at a corresponding position in the second packed data source operand, where each data element is 16 bits and stores a signed value, and wherein each of the plurality of output values is 32 bits; round each of the plurality of output values; detect whether any of the plurality of output values reflect an overflow or underflow; for any of the plurality of output values that reflect an overflow or underflow, saturate the output value; and store the plurality of output values into a corresponding plurality of positions of the packed data destination operand.

In some embodiments, the instruction is committed or retired at 409.

### EXAMPLES

Exemplary embodiments are detailed below.

1. An apparatus comprising: a decoder to decode an instruction having fields for a first packed data source operand, a second packed data source operand, and a packed data destination operand, and execution circuitry to execute the decoded instruction to: perform a fractional multiplication operation for each of a plurality of pairs of packed data elements to yield a plurality of output values, wherein each pair of the plurality of pairs includes a first packed data element of the first packed data source operand and a second packed data element at a corresponding position in the second packed data source operand, wherein each data element is 16 bits and stores a signed value, and wherein each of the plurality of output values is 32 bits; round each of the plurality of output values; detect whether any of the plurality of output values reflect an overflow or underflow; for any of the plurality of output values that reflect an overflow or underflow, saturate the output value; and store the plurality of output values into a corresponding plurality of positions of the packed data destination operand.

2. The apparatus of example 1, wherein the first packed data source operand is a packed data register and the second packed data source operand is a memory location.

3. The apparatus of example 1, wherein the first packed data source operand is a packed data register and the second packed data source operand is a packed data register.

4. The apparatus of any one of examples 1-3, wherein each of the rounded plurality of output values is 16 bits.

5. The apparatus of any one of examples 1-4, wherein said execution circuitry is further to: determine, based on one or more bit values of a control register, which rounding type of a plurality of candidate rounding types to utilize to round the plurality of output values.

6. The apparatus of example 5, wherein the plurality of candidate rounding types includes at least two of the following: truncate; round up; and convergent.

7. The apparatus of any one of examples 1-6, wherein the execution circuitry is further to, responsive to a detection that at least one of the output values reflects an overflow or underflow, set a value in a control register.

8. A method comprising: decoding an instruction having fields for a first packed data source operand, a second packed data source operand, and a packed data destination operand, and executing the decoded instruction to: perform a fractional multiplication operation for each of a plurality of pairs of packed data elements to yield a plurality of output values, wherein each pair of the plurality of pairs includes a first packed data element of the first packed data source operand and a second packed data element at a corresponding position in the second packed data source operand, wherein each data element is 16 bits and stores a signed value, and wherein each of the plurality of output values is 32 bits; round each of the plurality of output values; detect whether any of the plurality of output values reflect an overflow or underflow; for any of the plurality of output values that reflect an overflow or underflow, saturate the output value; and store the plurality of output values into a corresponding plurality of positions of the packed data destination operand.

9. The method of example 8, wherein the first packed data source operand is a packed data register and the second packed data source operand is a memory location.

10. The method of example 8, wherein the first packed data source operand is a packed data register and the second packed data source operand is a packed data register.

11. The method of any one of examples 8-10, wherein each of the rounded plurality of output values is 16 bits.

12. The method of any one of examples 8-11, wherein said execution circuitry is further to: determine, based on one or more bit values of a control register, which rounding type of a plurality of candidate rounding types to utilize to round the plurality of output values.

13. The method of example 12, wherein the plurality of candidate rounding types includes at least two of the following: truncate; round up; and convergent.

14. The method of any one of examples 8-13, wherein the execution circuitry is further to, responsive to a detection that at least one of the output values reflects an overflow or underflow, set a value in a control register.

15. A non-transitory machine-readable medium storing an instruction which, when executed by a processor, causes the processor to perform a method, the method comprising: decoding the instruction, the instruction having fields for a first packed data source operand, a second packed data source operand, and a packed data destination operand, and executing the decoded instruction to: perform a fractional multiplication operation for each of a plurality of pairs of packed data elements to yield a plurality of output values, wherein each pair of the plurality of pairs includes a first packed data element of the first packed data source operand and a second packed data element at a corresponding position in the second packed data source operand, wherein each data element is 16 bits and stores a signed value, and wherein each of the plurality of output values is 32 bits; round each of the plurality of output values; detect whether any of the plurality of output values reflect an overflow or underflow; for any of the plurality of output values that reflect an overflow or underflow, saturate the output value; and store the plurality of output values into a corresponding plurality of positions of the packed data destination operand.

16. The non-transitory machine-readable medium of example 15, wherein the first packed data source operand is a packed data register and the second packed data source operand is a memory location.

17. The non-transitory machine-readable medium of example 15, wherein the first packed data source operand is a packed data register and the second packed data source operand is a packed data register.

18. The non-transitory machine-readable medium of any one of examples 15-17, wherein each of the rounded plurality of output values is 16 bits.

19. The non-transitory machine-readable medium of any one of examples 15-18, wherein said execution circuitry is further to: determine, based on one or more bit values of a control register, which rounding type of a plurality of candidate rounding types to utilize to round the plurality of output values.

20. The non-transitory machine-readable medium of example 19, wherein the plurality of candidate rounding types includes at least two of the following: truncate; round up; and convergent.

21. The non-transitory machine-readable medium of any one of examples 15-20, wherein the execution circuitry is further to, responsive to a detection that at least one of the output values reflects an overflow or underflow, set a value in a control register.

22. An apparatus comprising: a decoder means for decoding an instruction having fields for a first packed data source operand, a second packed data source operand, and a packed data destination operand, and execution means for executing the decoded instruction to: perform a fractional multiplication operation for each of a plurality of pairs of packed data elements to yield a plurality of output values, wherein each pair of the plurality of pairs includes a first packed data element of the first packed data source operand and a second packed data element at a corresponding position in the second packed data source operand, wherein each data element is 16 bits and stores a signed value, and wherein each of the plurality of output values are 32 bits; round each of the plurality of output values; detect whether any of the plurality of output values reflect an overflow or underflow; for any of the plurality of output values that reflect an overflow or underflow, saturate the output value; and store the plurality of output values into a corresponding plurality of positions of the packed data destination operand.

23. The apparatus of example 22, wherein the first packed data source operand is a packed data register and the second packed data source operand is a memory location.

24. The apparatus of example 22, wherein the first packed data source operand is a packed data register and the second packed data source operand is a packed data register.

25. The apparatus of any one of examples 22-24, wherein each of the rounded plurality of output values is 16 bits.

26. The apparatus of any one of examples 22-25, wherein said execution means is further to: determine, based on one or more bit values of a control register, which rounding type of a plurality of candidate rounding types to utilize to round the plurality of output values.

27. The apparatus of example 26, wherein the plurality of candidate rounding types includes at least two of the following: truncate; round up; and convergent.

28. The apparatus of any one of examples 22-27, wherein the execution means is further to, responsive to a detection that at least one of the output values reflects an overflow or underflow, set a value in a control register.

29. A machine readable medium including code, when executed, to cause a machine to perform the methods of examples 8-14.

30. An apparatus comprising means to perform a method of any of examples 8-14.

31. A machine-readable storage including machine-readable instructions, when executed, to implement a method of any one of examples 8-14 or realise an apparatus of any one of examples 1-7 or 22-28.

The figures below detail exemplary architectures and systems to implement embodiments of the above. In some embodiments, one or more hardware components and/or instructions described above are emulated as detailed below, or implemented as software modules.

### Instruction Sets

An instruction set includes one or more instruction formats. A given instruction format defines various fields (number of bits, location of bits) to specify, among other things, the operation to be performed (opcode) and the operand(s) on which that operation is to be performed. Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an instruction set architecture (ISA) is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### VEX Instruction Format

VEX encoding allows instructions to have more than two operands, and allows SIMD vector registers to be longer than 58 bits. The use of a VEX prefix provides for three-operand (or more) syntax. For example, previous two-operand instructions performed operations such as A=A+B, which overwrites a source operand. The use of a VEX prefix enables operands to perform nondestructive operations such as A=B+C.

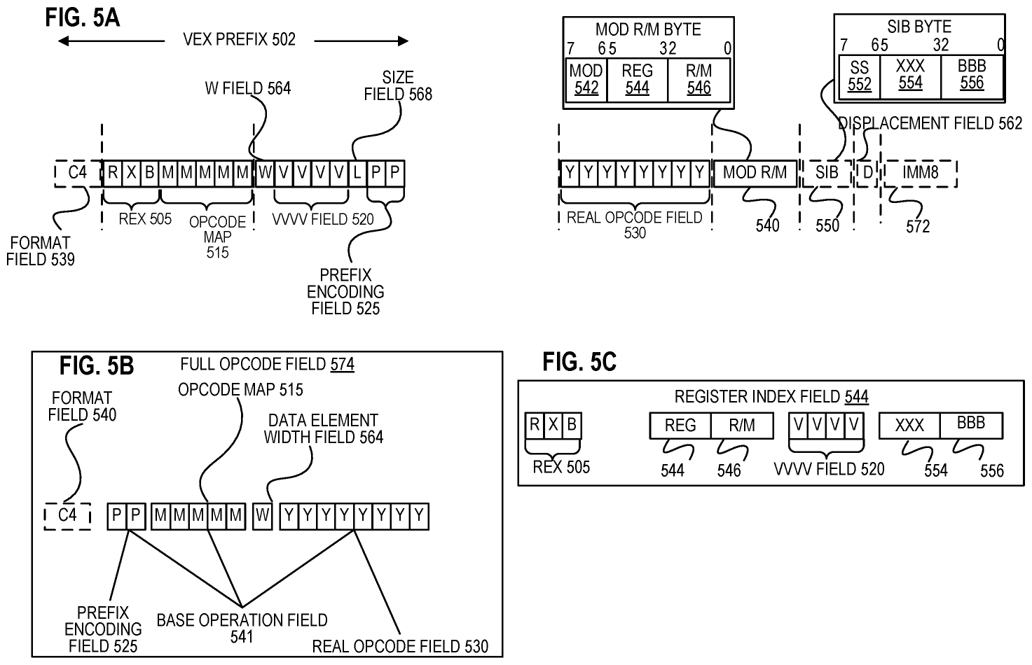

FIG. 5A illustrates an exemplary AVX instruction format including a VEX prefix 502, real opcode field 530, Mod R/M byte 540, SIB byte 550, displacement field 562, and IMM8 572. FIG. 5B illustrates which fields from FIG. 5A make up a full opcode field 574 and a base operation field 541. FIG. 5C illustrates which fields from FIG. 5A make up a register index field 544.

VEX Prefix (Bytes 0-2) 502 is encoded in a three-byte form. The first byte is the Format Field 539 (VEX Byte 0, bits [7:0]), which contains an explicit C4 byte value (the unique value used for distinguishing the C4 instruction format). The second-third bytes (VEX Bytes 1-2) include a number of bit fields providing specific capability. Specifically, REX field 505 (VEX Byte 1, bits [7-5]) consists of a VEX.R bit field (VEX Byte 1, bit [7]−R), VEX.X bit field (VEX byte 1, bit [6]−X), and VEX.B bit field (VEX byte 1, bit[5]−B). Other fields of the instructions encode the lower three bits of the register indexes as is known in the art (rrr, xxx, and bbb), so that Rrrr, Xxxx, and Bbbb may be formed by adding VEX.R, VEX.X, and VEX.B. Opcode map field 515 (VEX byte 1, bits [4:0]−mmmmm) includes content to encode an implied leading opcode byte. W Field 564 (VEX byte 2, bit [7]−W)—is represented by the notation VEX.W, and provides different functions depending on the instruction. The role of VEX.vvvv 520 (VEX Byte 2, bits [6:3]-vvvv) may include the following: 1) VEX.vvvv encodes the first source register operand, specified in inverted (1s complement) form and is valid for instructions with 2 or more source operands; 2) VEX.vvvv encodes the destination register operand, specified in is complement form for certain vector shifts; or 3) VEX.vvvv does not encode any operand, the field is reserved and should contain 1111b. If VEX.L 568 Size field (VEX byte 2, bit [2]-L)=0, it indicates 58-bit vector; if VEX.L=1, it indicates 256-bit vector. Prefix encoding field 525 (VEX byte 2, bits [1:0]-pp) provides additional bits for the base operation field 541.

Real Opcode Field 530 (Byte 3) is also known as the opcode byte. Part of the opcode is specified in this field.

MOD R/M Field 540 (Byte 4) includes MOD field 542 (bits [7-6]), Reg field 544 (bits [5-3]), and R/M field 546 (bits [2-0]). The role of Reg field 544 may include the following: encoding either the destination register operand or a source register operand (the rrr of Rrrr), or be treated as an opcode extension and not used to encode any instruction operand. The role of R/M field 546 may include the following: encoding the instruction operand that references a memory address, or encoding either the destination register operand or a source register operand.

Scale, Index, Base (SIB)—The content of Scale field 550 (Byte 5) includes SS552 (bits [7-6]), which is used for memory address generation. The contents of SIB.xxx 554 (bits [5-3]) and SIB.bbb 556 (bits [2-0]) have been previously referred to with regard to the register indexes Xxxx and Bbbb.

The Displacement Field 562 and the immediate field (IMM8) 572 contain data.

### Exemplary Register Architecture

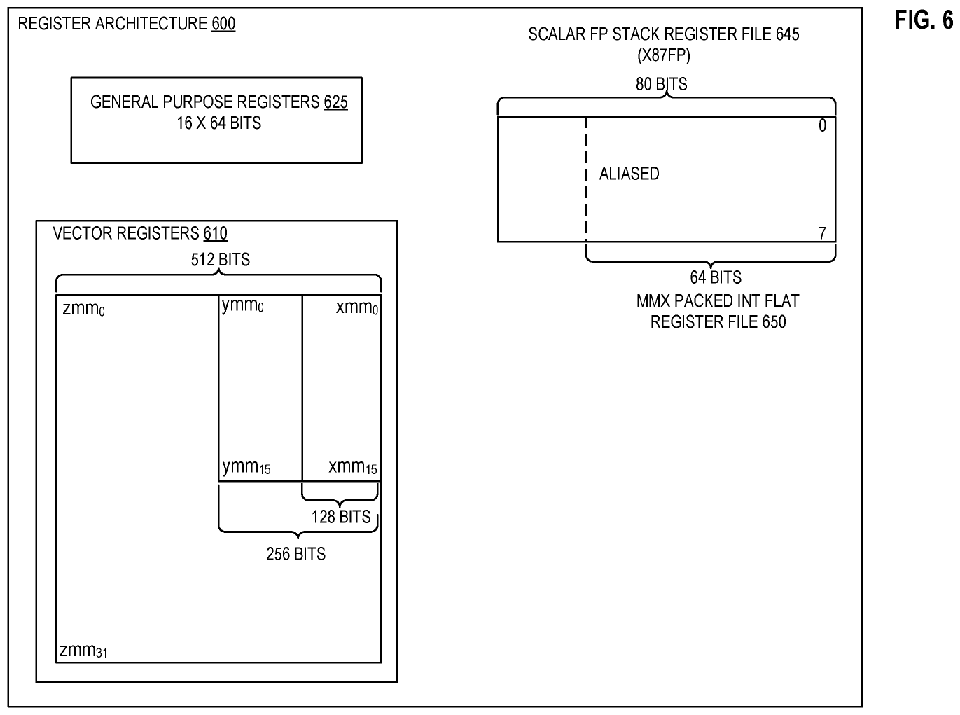

FIG. 6 is a block diagram of a register architecture 600 according to some embodiments. In the embodiment illustrated, there are 32 vector registers 610 that are 512 bits wide; these registers are referenced as zmm0 through zmm31. The lower order 256 bits of the lower 9 zmm registers are overlaid on registers ymm0-15. The lower order 128 bits of the lower 9 zmm registers (the lower order 128 bits of the ymm registers) are overlaid on registers xmm0-15.

General-purpose registers 625—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 645, on which is aliased the MMX packed integer flat register file 650—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments may use wider or narrower registers. Additionally, alternative embodiments may use more, fewer, or different register files and registers.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a central processing unit (CPU) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures. Detailed herein are circuits (units) that comprise exemplary cores, processors, etc.

### Exemplary Core Architectures

### In-Order and Out-of-Order Core Block Diagram

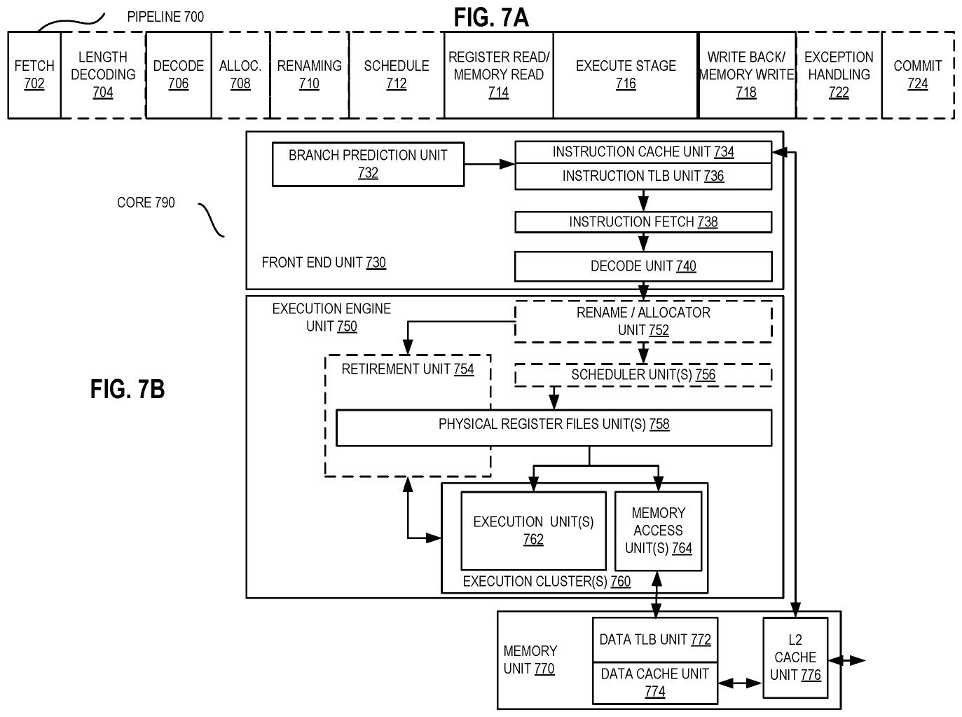

FIG. 7A is a block diagram illustrating both an exemplary in-order pipeline and an exemplary register renaming, out-of-order issue/execution pipeline according to some embodiments. FIG. 7B is a block diagram illustrating both an exemplary embodiment of an in-order architecture core and an exemplary register renaming, out-of-order issue/execution architecture core to be included in a processor according to some embodiments. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front-end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front-end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general-purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) on various types of data (e.g., scalar floating point, packed integer, packed floating point, vector integer, vector floating point). Execution units 762 may include DSP hardware, and may share a scheduler port with vector execution units and/or fused multiply-add (FMA) execution units.

While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch unit 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, California; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary In-Order Core Architecture

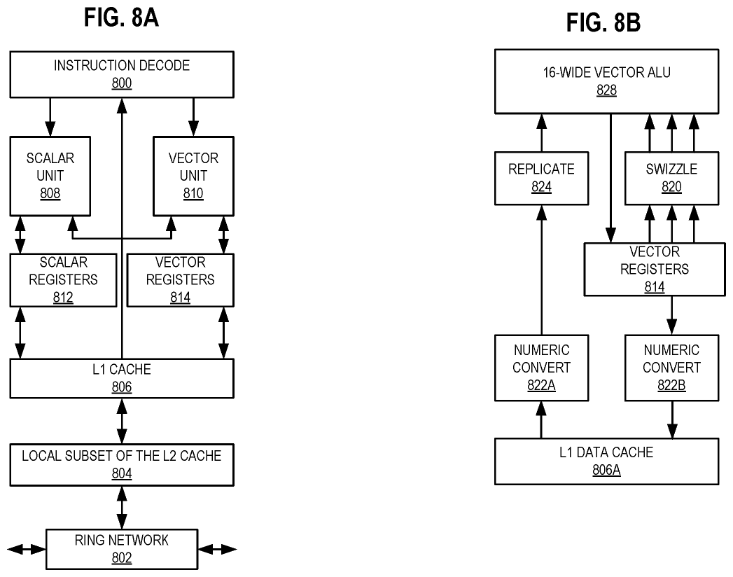

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory input/output (I/O) interfaces, and other necessary I/O logic, depending on the application.

FIG. 8A is a block diagram of a single processor core, along with its connection to the on-die interconnect network 802 and with its local subset of the Level 2 (L2) cache 804, according to some embodiments. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments may use a different approach (e.g., use a single register set or include a communication path that allow data to be transferred between the two register files without being written and read back).

The local subset of the L2 cache 804 is part of a global L2 cache that is divided into separate local subsets, one per processor core. Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bi-directional to allow agents such as processor cores, L2 caches and other logic blocks to communicate with each other within the chip. Each ring data-path is 1024-bits wide per direction in some embodiments.

FIG. 8B is an expanded view of part of the processor core in FIG. 8A according to some embodiments. FIG. 8B includes an L1 data cache 806A part of the L1 cache 804, as well as more detail regarding the vector unit 810 and the vector registers 814. Specifically, the vector unit 810 is a 9-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input.

Processor with Integrated Memory Controller and Graphics

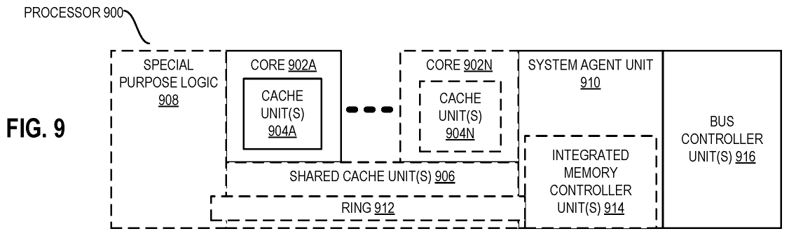

FIG. 9 is a block diagram of a processor 900 that may have more than one core, may have an integrated memory controller, and may have integrated graphics according to some embodiments. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like.

The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores 904A-N, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the integrated graphics logic 908, the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902-A-N.

In some embodiments, one or more of the cores 902A-N are capable of multi-threading. The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set.

### Exemplary Computer Architectures

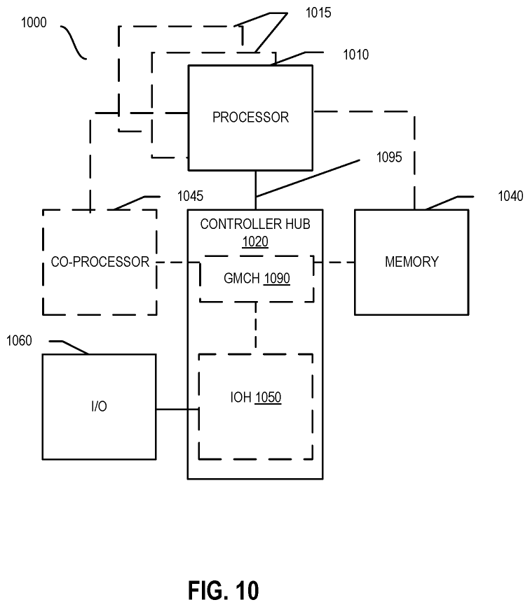

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with some embodiments. The system 1000 may include one or more processors 1010, 1015, which are coupled to a controller hub 1020. In one embodiment, the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 couples I/O devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processing cores described herein and may be some version of the processor 900.

The memory 1040 may be, for example, dynamic random-access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface, or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 10155 in terms of a spectrum of metrics of merit including architectural, microarchitectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

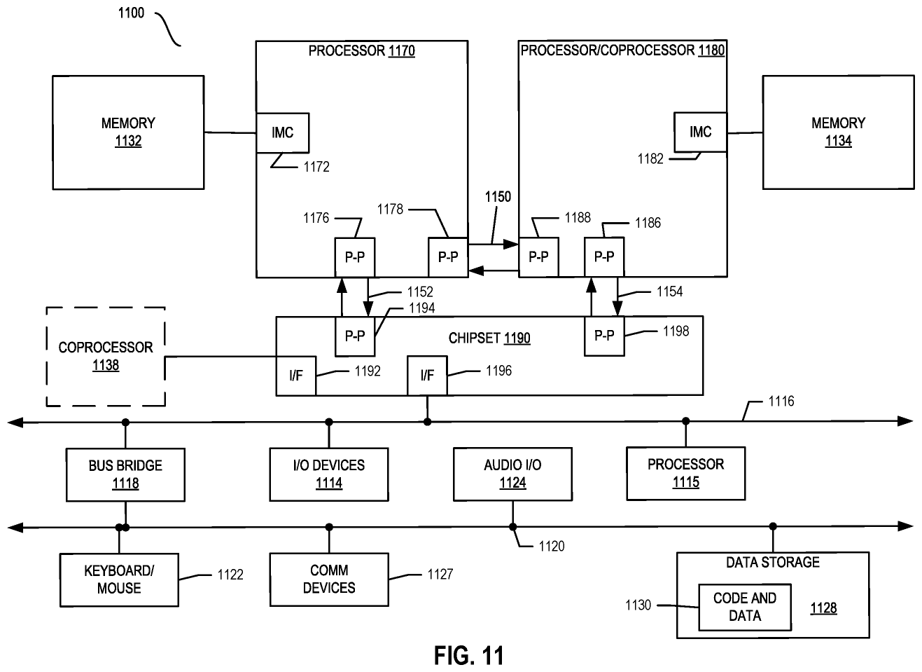

Referring now to FIG. 11, shown is a block diagram of a first more specific exemplary system 1100 in accordance with some embodiments. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In some embodiments, processors 1170 and 1180 are respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1192. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another I/O interconnect bus, although other options exist that may be known to those of skill in the art.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1116. Note that other architectures are possible. For example, instead of the point-to-point architecture of FIG. 11, a system may implement a multi-drop bus or other such architecture.

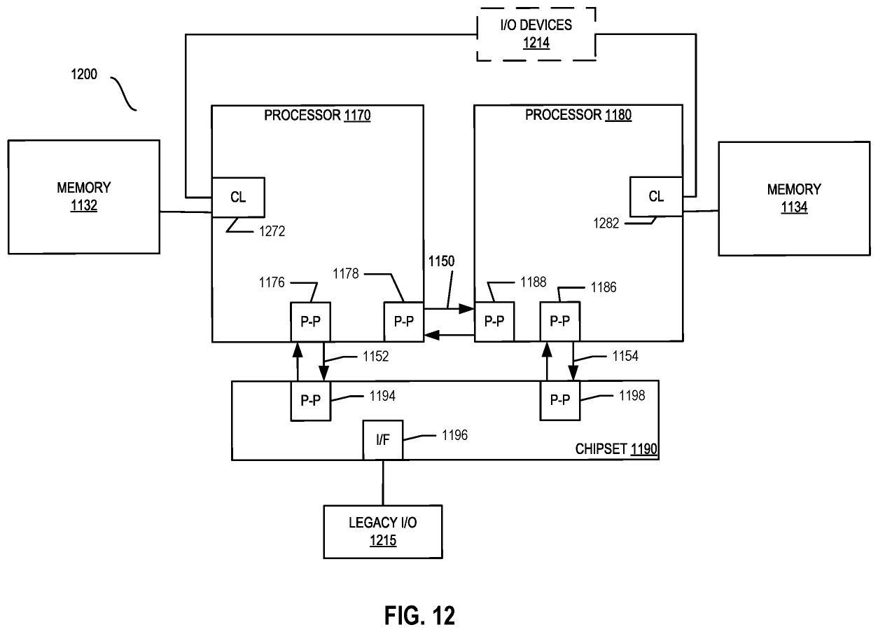

Referring now to FIG. 12, shown is a block diagram of a second more specific exemplary system 1200 in accordance with some embodiments Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1272 and 1282, respectively. Thus, the CL 1272, 1282 include integrated memory controller units and include I/O control logic. FIG. 12 illustrates that not only are the memories 1132, 1134 coupled to the CLs 1272, 1282, but also that I/O devices 1214 are also coupled to the CLs 1272, 1282. Legacy I/O devices 1215 are coupled to the chipset 1190.

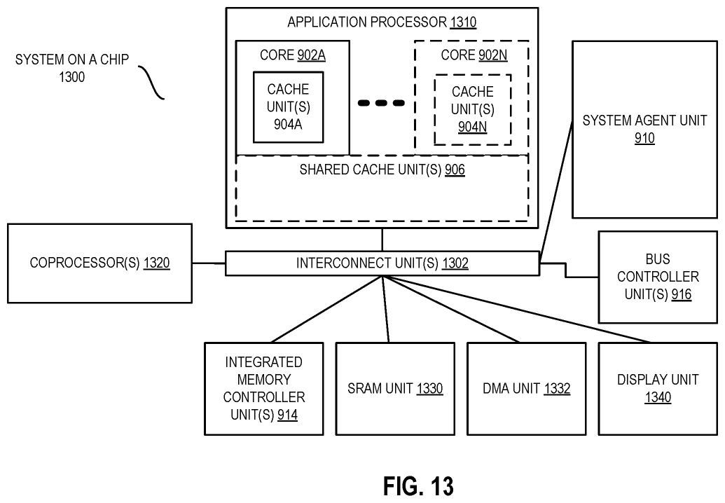

Referring now to FIG. 13, shown is a block diagram of a SoC 1300 in accordance with some embodiments. Similar elements in FIG. 9 bear like reference numerals. Also, dashed lined boxes are optional features on more advanced SoCs. In FIG. 13, an interconnect unit(s) 1302 is coupled to: an application processor 1310 which includes a set of one or more cores 132A-N, cache units 904A-N, and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

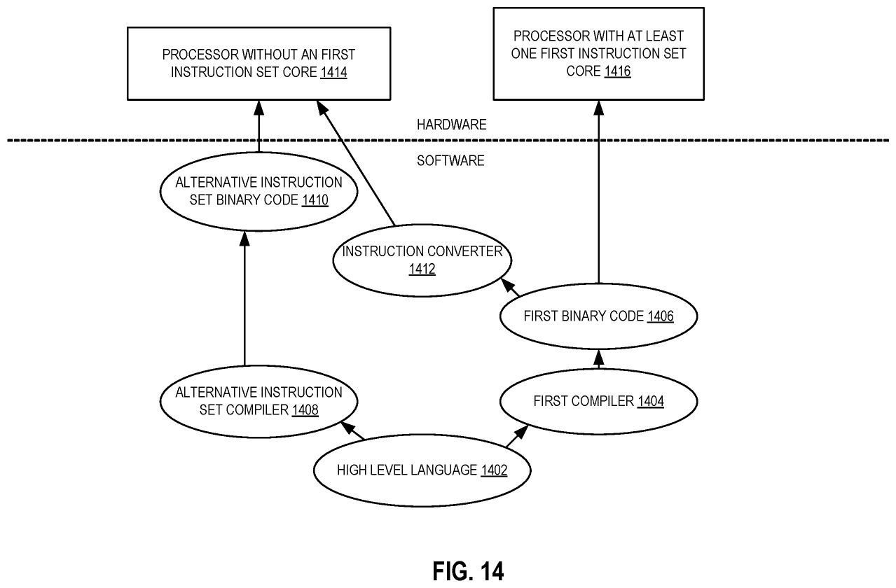

FIG. 14 is a block diagram contrasting the use of a software instruction converter to convert binary instructions in a source instruction set to binary instructions in a target instruction set according to some embodiments. In the illustrated embodiment, the instruction converter is a software instruction converter, although alternatively the instruction converter may be implemented in software, firmware, hardware, or various combinations thereof. FIG. 14 shows a program in a high-level language 1402 may be compiled using a first compiler 1404 to generate a first binary code (e.g., x86) 1406 that may be natively executed by a processor with at least one first instruction set core 1416. In some embodiments, the processor with at least one first instruction set core 1416 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The first compiler 1404 represents a compiler that is operable to generate binary code of the first instruction set 1406 (e.g., object code) that can, with or without additional linkage processing, be executed on the processor with at least one first instruction set core 1416. Similarly, FIG. 14 shows the program in the high-level language 1402 may be compiled using an alternative instruction set compiler 1408 to generate alternative instruction set binary code 1410 that may be natively executed by a processor without at least one first instruction set core 1414 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1412 is used to convert the first binary code 1406 into code that may be natively executed by the processor without a first instruction set core 1414. This converted code is not likely to be the same as the alternative instruction set binary code 1410 because an instruction converter capable of this is difficult to make; however, the converted code will accomplish the general operation and be made up of instructions from the alternative instruction set. Thus, the instruction converter 1412 represents software, firmware, hardware, or a combination thereof that, through emulation, simulation or any other process, allows a processor or other electronic device that does not have a first instruction set processor or core to execute the first binary code 1406.

1. An apparatus comprising:
a decoder to decode an instruction having fields for a first packed data source operand, a second packed data source operand, and a packed data destination operand, and
execution circuitry to execute the decoded instruction to:
perform a fractional multiplication operation for each of a plurality of pairs of packed data elements to yield a plurality of output values, wherein each pair of the plurality of pairs includes a first packed data element of the first packed data source operand and a second packed data element at a corresponding position in the second packed data source operand, wherein each data element is 16 bits and stores a signed value, and wherein each of the plurality of output values are 32 bits;
round each of the plurality of output values;
detect whether any of the plurality of output values reflect an overflow;
for any of the plurality of output values that reflect an overflow, saturate the output value; and
store the plurality of output values into a corresponding plurality of positions of the packed data destination operand.

2. The apparatus of claim 1, wherein the first packed data source operand is a packed data register and the second packed data source operand is a memory location.

3. The apparatus of claim 1, wherein the first packed data source operand is a packed data register and the second packed data source operand is a packed data register.

4. The apparatus of claim 1, wherein each of the rounded plurality of output values is 16 bits.

5. The apparatus of claim 1, wherein said execution circuitry is further to:
determine, based on one or more bit values of a control register, which rounding type of a plurality of candidate rounding types to utilize to round the plurality of output values.

6. The apparatus of claim 5, wherein the plurality of candidate rounding types includes at least two of the following: truncate; round up; and convergent.

7. The apparatus of claim 1, wherein the execution circuitry is further to, responsive to a detection that at least one of the output values reflects an overflow, set a value in a control register.

8. A method comprising:
decoding an instruction having fields for a first packed data source operand, a second packed data source operand, and a packed data destination operand, and
executing the decoded instruction to:
perform a fractional multiplication operation for each of a plurality of pairs of packed data elements to yield a plurality of output values, wherein each pair of the plurality of pairs includes a first packed data element of the first packed data source operand and a second packed data element at a corresponding position in the second packed data source operand, wherein each data element is 16 bits and stores a signed value, and wherein each of the plurality of output values is 32 bits;
round each of the plurality of output values;
detect whether any of the plurality of output values reflect an overflow;
for any of the plurality of output values that reflect an overflow, saturate the output value; and
store the plurality of output values into a corresponding plurality of positions of the packed data destination operand.

9. The method of claim 8, wherein the first packed data source operand is a packed data register and the second packed data source operand is a memory location.

10. The method of claim 8, wherein the first packed data source operand is a packed data register and the second packed data source operand is a packed data register.

11. The method of claim 8, wherein each of the rounded plurality of output values is 16 bits.

12. The method of claim 8, wherein said execution circuitry is further to:
determine, based on one or more bit values of a control register, which rounding type of a plurality of candidate rounding types to utilize to round the plurality of output values.

13. The method of claim 12, wherein the plurality of candidate rounding types includes at least two of the following: truncate; round up; and convergent.

14. The method of claim 8, wherein the execution circuitry is further to, responsive to a detection that at least one of the output values reflects an overflow, set a value in a control register.

15. A non-transitory machine-readable medium storing an instruction which, when executed by a processor, causes the processor to perform a method, the method comprising:
decoding the instruction, the instruction having fields for a first packed data source operand, a second packed data source operand, and a packed data destination operand, and
executing the decoded instruction to:
perform a fractional multiplication operation for each of a plurality of pairs of packed data elements to yield a plurality of output values, wherein each pair of the plurality of pairs includes a first packed data element of the first packed data source operand and a second packed data element at a corresponding position in the second packed data source operand, wherein each data element is 16 bits and stores a signed value, and wherein each of the plurality of output values is 32 bits;
round each of the plurality of output values;
detect whether any of the plurality of output values reflect an overflow;
for any of the plurality of output values that reflect an overflow, saturate the output value; and
store the plurality of output values into a corresponding plurality of positions of the packed data destination operand.

16. The non-transitory machine-readable medium of claim 15, wherein the first packed data source operand is a packed data register and the second packed data source operand is a memory location.

17. The non-transitory machine-readable medium of claim 15, wherein the first packed data source operand is a packed data register and the second packed data source operand is a packed data register.

18. The non-transitory machine-readable medium of claim 15, wherein each of the rounded plurality of output values is 16 bits.

19. The non-transitory machine-readable medium of claim 15, wherein said execution circuitry is further to:
determine, based on one or more bit values of a control register, which rounding type of a plurality of candidate rounding types to utilize to round the plurality of output values.

20. The non-transitory machine-readable medium of claim 19, wherein the plurality of candidate rounding types includes at least two of the following: truncate; round up; and convergent.

21-25. (canceled)
